(19) United States
(12) Patent Application Publication
(10) Pub. No.: US 2009/0082245 A1
(43) Pub. Date: Mar. 26, 2009

(54) METHOD FOR FORMULATING A BRANDED CLEANING PRODUCT

(75) Inventors: Kim R. Smith, Woodbury, MN (US); Keith E. Olson, Apple Valley, MN (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 12/263,892

(22) Filed: Nov. 3, 2008

Related U.S. Application Data
(63) Continuation-in-part of application No. 12/114,327, filed on May 2, 2008.
(60) Provisional application No. 60/927,575, filed on May 4, 2007.

(51) Int. Cl. C11D 3/20

(52) U.S. Cl. 510/336; 510/356; 510/337; 510/403; 510/404; 510/433; 510/446

(57) ABSTRACT

An aminocarboxylate- or polycarboxylate-containing cleaning product manufactured or sold in association with a brand may be replaced by a substitute similarly-branded cleaning product or cleaning system containing less of one or both of the aminocarboxylate or polycarboxylate, and containing (or used with a water treatment product containing) sufficient magnesium compound to provide commercially acceptable cleaning performance when the substitute cleaning product contains or is used with hard water.

### CROSS-REFERENCE TO RELATED APPLICATIONS

This application is a continuation-in-part of U.S. patent application Ser. No. 12/114,327, filed May 2, 2008, entitled “Water Soluble Magnesium Compounds as Cleaning Agents and Methods of Using Them”, and which claims priority to U.S. Provisional Application Ser. No. 60/927,575, filed May 4, 2007 and entitled “Compositions Containing Magnesium Salt and Methods of Using”.

### TECHNICAL FIELD

This invention relates to cleaning products, including ware washing compositions, laundry detergents, hard surface cleaners, rinse aids and other compositions for cleaning hard or soft surfaces.

### BACKGROUND

Cleaning products typically contain a large number of carefully chosen ingredients. The individual ingredients normally each serve some specialized function, for example breaking down or solvating soils (e.g., by providing one or both of a source of alkalinity or enzymes), disinfecting, bleaching, preventing color loss, optical brightening, preventing foaming, offsetting the effects of hard water, aiding rinsing or drying, or making the product safer or more pleasant to use.

Large-selling cleaning products typically are manufactured and sold under a brand. A single brand is often employed to identify and unify a family of related cleaning products, with appropriate additional text or graphics being added as need be to designate individual family members. For example, a single unifying brand might be employed on powder, liquid, enzyme-containing, bleach-containing and scented product versions of a laundry detergent, with added text or graphics (serving in some instances as a further trademark or service mark) being used to distinguish the various family members. The brand serves to identify one or more of the product source, quality or performance, and assists a consumer or other end-user in repurchasing the desired product, selecting an appropriate new product when improved or altered variants within the brand family appear in a marketplace, or selecting an appropriate substitute product from the same or a different source when for any reason the desired product is not repurchased.

Cleaning product formulations sometimes have to be changed, for reasons including changes in raw material cost, raw material availability, regulatory requirements, product performance requirements, or the manner in which a product might be used. When the formulation change involves a branded cleaning product, it normally will be necessary to maintain or at least not significantly decrease the product performance characteristics which consumers associate with products sold under the brand name, so as to avoid loss of goodwill for the changed product, for other related products sold under the brand, or even for products manufactured or sold in association with other brands by the same supplier. Considerable effort and testing may be required in order to make some formulation changes, since there usually is a very wide assortment of potential ingredients which might be used to address each desired product performance characteristic, and because ingredients selected to address one product performance characteristic may adversely affect another ingredient or another product performance characteristic.

Most cleaning products contain one or more ingredients whose presence offsets the effects of hard water. Examples include aminocarboxylates (for example, ethylenediaminetetraacetic acid (EDTA), diethylenetriaminepentaacetic acid (DTPA), nitrilotriacetic acid (NTA) and their salts) and polycarboxylates (for example, polyacrylates, polymethacrylates and olefin/maleic acid copolymers). Unfortunately many aminocarboxylates and polycarboxylates have poor biodegradability, and those with better biodegradability typically are very costly. The European Union recently recommended adoption of a variety of risk reduction measures to limit sodium EDTA levels in river basins and elsewhere (see OJ L 104, Nov. 4, 2006, pp. 45-47).

### SUMMARY OF THE INVENTION

The present invention provides, in one aspect, a method for formulating a cleaning product, which method comprises:
(a) manufacturing or selling, in association with a brand, a cleaning product containing sufficient aminocarboxylate or polycarboxylate to provide commercially acceptable cleaning performance when the cleaning product contains or is used with hard water;
(b) formulating a substitute cleaning product containing less of one or both of the aminocarboxylate or polycarboxylate, and containing sufficient magnesium compound to provide comparable or improved cleaning performance when the substitute cleaning product contains or is used with hard water; and
(c) manufacturing or selling the substitute cleaning product in association with the brand.

The invention provides, in another aspect, a method for formulating a cleaning system, which method comprises:
(a) manufacturing or selling, in association with a brand, a cleaning product containing sufficient aminocarboxylate or polycarboxylate to provide commercially acceptable cleaning performance when the cleaning product contains or is used with hard water;
(b) formulating a substitute cleaning product containing less of one or both of the aminocarboxylate or polycarboxylate;
(c) manufacturing or selling the substitute cleaning product in association with the brand, for use together with a water treatment product containing sufficient magnesium compound to provide comparable or improved cleaning performance when the substitute cleaning product is used with water treated using the water treatment product.

The disclosed methods enable reduction or elimination of ingredients that may be or may become commercially unacceptable for environmental, cost or other reasons, while substantially preserving or even increasing the cleaning performance levels associated with a branded cleaning product.

### BRIEF DESCRIPTION OF THE DRAWING

FIG. 1 is a schematic drawing of a family of branded cleaning products;

FIG. 2 is a photograph of glasses treated with varying ratios of magnesium oxide to calcite;

FIG. 3 is a photograph of glasses rinsed with either treated or untreated water;

FIG. 4 is a photograph of a glass washed with a conventional detergent and untreated water;

FIG. 5 is a photograph of a glass washed with a chelating agent-free detergent and treated water; and

FIG. 6 is a photograph of a control glass rinsed using hard water alone and five glasses rinsed using a rinse agent that provided 1:1, 1.5:1, 2:1, 2.5:1, or 3:1 molar ratios of magnesium to calcium.

Like reference symbols in the various figures of the drawing indicate like elements. The elements in the drawing are not to scale.

### DETAILED DESCRIPTION

The following detailed description describes certain illustrative embodiments and is not to be taken in a limiting sense. All weights, amounts and ratios are by weight, unless otherwise specifically noted. Unless the context indicates otherwise the following terms shall have the following meaning and shall be applicable to the singular and plural:

The terms “a,” “an,” “the,” “at least one,” and “one or more” are used interchangeably. Thus a cleaning product that contains “a” magnesium compound may include “one or more” magnesium compounds.

The term “about” modifying the quantity of an ingredient in a composition or mixture or employed in the disclosed methods refers to variations such as may occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition made from a particular initial mixture. Whether or not modified by the term “about”, the claims include equivalents to the recited quantities.

The term “antiredeposition agent” refers to a compound that helps keep water hardness ions suspended in water instead of depositing or redepositing onto an object being cleaned.

The term “brand” refers to a name, symbol, logo, slogan, design or other indicia, including trademarks, service marks and portions thereof, whether or not registered, that a potential purchaser or user of a product or service perceives as representing an expected level of quality or performance for products or services manufactured or sold in association with the brand.

The terms “chelating agent” and “sequestrant” refer to a compound that forms a complex (soluble or not) with water hardness ions (e.g., from water already present in a cleaning composition, water added to a cleaning composition, wash water, rinse water, soil or a substrate being cleaned) in a specific molar ratio. The terms “chelating agent” and “sequestrant” normally are synonyms, and the term chelating agent will be used to refer to both chelating agents and sequestrants in the remainder of this application. Chelating agents that can form a water soluble complex include acids (or more commonly salts thereof, including sodium or potassium salts) such as sodium tripolyphosphate, EDTA, DTPA, NTA, citric acid, and the like, as well as other materials such as zeolites. The term “free of chelating agent” refers to a composition, mixture, or ingredient that does not contain a chelating agent or to which a chelating agent has not deliberately been added. This term encompasses however the presence of chelating agents as unintended or unavoidable impurities, e.g., through the formulation by a manufacturer or dilution by an end user of a cleaning composition using water containing one or more chelating agents in trace amounts. For example, a recent study noted that metal-EDTA complexes have been found in amounts of 0.52 to 1120 μg/L in European surface waters, see Oviedo et al., EDTA: the chelating agent under environmental scrutiny, Quimica Nova, 26, 6, November/December 2003, and the use of such surface waters or similar EDTA-containing surface waters to manufacture or dilute a composition, mixture, or ingredient to which no other chelating agent had been added would still represent a composition, mixture or ingredient free of chelating agent. The term “substantially free of chelating agent” refers to a composition, mixture, or ingredient containing less than 0.2 wt. % chelating agent. The term “lacking an effective amount of chelating agent” refers to a composition, mixture, or ingredient containing too little chelating agent to affect measurably the hardness of water present in or employed with such composition, mixture or ingredient.

The term “cleaning” refers to performing or aiding in soil removal, bleaching, microbial population reduction, rinsing, or combination thereof.

The term “cleaning product” refers to a composition for cleaning hard or soft surfaces, including ware washing compositions, laundry detergents, hard surface cleaners and rinse aids.

The term “cleaning system” refers to a cleaning product and a water treatment product used together to clean hard or soft surfaces. The cleaning system components may be used contemporaneously, consecutively or combinations thereof. For example, a water treatment product may be used to treat water (e.g., in a water inlet line) which is then combined with the cleaning product and used to clean a hard or soft surface; by employing both the cleaning product and water treatment product at the same time (e.g., by adding both a cleaning product and a water treatment product to a ware wash or laundry cycle, or by applying both to a hard surface); or by using the cleaning product followed by rinsing, before the cleaned surface has had a chance to dry, using water treated with the water treatment product.

The term “commercially acceptable cleaning performance” refers generally to the degree of cleanliness, extent of effort, or both that a typical consumer would expect to achieve or expend when using a cleaning product or cleaning system to address a typical soiling condition on a typical substrate. This degree of cleanliness may, depending on the particular cleaning product and particular substrate, correspond to a general absence of visible soils, or to some lesser degree of cleanliness. For example, a shower cleaner or toilet bowl cleaner would be expected by a typical consumer to achieve an absence of visible soils when used on a moderately soiled but relatively new hard surface, but would not be expected to achieve an absence of visible soils when used on an old hard surface which already bears permanent stains such as heavy calcite deposits or iron discoloration. Cleanliness may be evaluated in a variety of ways depending on the particular cleaning product being used (e.g., ware or laundry detergent, rinse aid, hard surface cleaner, vehicular wash or rinse agent, or the like) and the particular hard or soft surface being cleaned (e.g., ware, laundry, fabrics, vehicles, and the like), and normally may be determined using generally agreed industry standard tests or localized variations of such tests. In the absence of such agreed industry standard tests, cleanliness may be evaluated using the test or tests already employed by a manufacturer or seller to evaluate the cleaning performance of its aminocarboxylate- or polycarboxylate-containing cleaning products sold in association with its brand.

The term “comparable cleaning performance” refers generally to achievement by a substitute cleaning product or substitute cleaning system of generally the same degree (or at least not a significantly lesser degree) of cleanliness or with generally the same expenditure (or at least not a significantly lesser expenditure) of effort, or both, when using the substitute cleaning product or substitute cleaning system rather than a branded aminocarboxylate- or polycarboxylate-containing cleaning to address a typical soiling condition on a typical substrate. This degree of cleanliness may, depending on the particular cleaning product and particular substrate, correspond to a general absence of visible soils, or to some lesser degree of cleanliness, as explained in the prior paragraph.

The term “hard surface” refers to a non-resilient cleanable substrate, for example materials made from ceramic, stone, glass or hard plastics including showers, sinks, toilets, bathtubs, countertops, windows, mirrors, transportation vehicles, walls, wooden or tile floors, patient-care equipment (for example diagnostic equipment, shunts, body scopes, wheel chairs, bed frames, etc.), surgical equipment and the like.

The term “improved cleaning performance” refers generally to achievement by a substitute cleaning product or substitute cleaning system of a generally greater degree of cleanliness or with generally a reduced expenditure of effort, or both, when using the substitute cleaning product or substitute cleaning system rather than a branded aminocarboxylate- or polycarboxylate-containing cleaning product to address a typical soiling condition on a typical substrate. This degree of cleanliness may, depending on the particular cleaning product and particular substrate, correspond to a general absence of visible soils, or to some lesser degree of cleanliness, as explained above.

The term “in association with” refers to use on a product or service, on product packaging, or in product or service advertising or instructions.

The terms “include” and “including” when used in reference to a list of materials refer to but are not limited to the materials so listed.

The term “phosphorus-free” refers to a composition, mixture, or ingredients that do not contain phosphorus-containing compounds or to which phosphorus or phosphorus-containing compounds have not deliberately been added. This term encompasses however the presence of phosphorus-containing compounds as unintended or unavoidable impurities, e.g., through the formulation by a manufacturer or dilution by an end user of a cleaning composition using water containing trace amounts of phosphorus-containing compounds. The term “substantially free of phosphorus” refers to a composition, mixture, or ingredients containing less than 0.2 wt. % phosphorus-containing compounds. The term “lacking an effective amount of phosphorus” refers to a composition, mixture, or ingredients containing too little phosphorus-containing compounds to affect measurably the hardness of water present in or employed with such composition, mixture or ingredient. The terms “phosphate-free” and “substantially free of phosphate” are defined similarly, with “phosphate” being substituted for “ ”phosphorus” in the above definitions.

The term “soft surface” refers to a resilient cleanable substrate, for example materials made from woven, nonwoven or knit textiles, leather, rubber or flexible plastics including fabrics (for example surgical garments, draperies, bed linens, bandages, etc.), carpet, transportation vehicle seating and interior components and the like.

The term “solid” refers to a composition in a generally shape-stable form under expected storage conditions, for example a powder, particle, agglomerate, flake, granule, pellet, tablet, lozenge, puck, briquette, brick or block, and whether in a unit dose or a portion from which measured unit doses may be withdrawn. A solid may have varying degrees of shape stability, but typically will not flow perceptibly and will substantially retain its shape under moderate stress, pressure or mere gravity, as for example, when a molded solid is removed from a mold, when an extruded solid exits an extruder, and the like. A solid may have varying degrees of surface hardness, and for example may range from that of a fused solid block whose surface is relatively dense and hard, resembling concrete, to a consistency characterized as being malleable and sponge-like, resembling a cured caulking material.

The term “substitute cleaning product” refers to a product that is intended to be or may be used in place of a cleaning product containing aminocarboxylate or polycarboxylate.

The term “threshold agent” refers to a compound that inhibits or alters crystallization of water hardness ions from solution, but that need not form a specific complex with the water hardness ion and thereby may be distinguished from a chelating agent. Threshold agents include polycarboxylates, for example polymers and copolymers of acrylic acid, methacrylic acid, maleic acid and olefins. The term “free of threshold agent” refers to a composition, mixture, or ingredient that does not contain a threshold agent or to which a threshold agent has not deliberately been added. This term encompasses however the presence of threshold agents as unintended or unavoidable impurities, e.g., through the formulation by a manufacturer or dilution by an end user of a cleaning composition using water containing one or more threshold agents in trace amount, and the use of such water to manufacture or dilute a composition, mixture, or ingredient to which no other threshold agent had been added would still represent a composition, mixture or ingredient free of threshold agent. The term “substantially free of threshold agent” refers to a composition, mixture, or ingredient containing less than 0.2 wt. % threshold agent. The term “lacking an effective amount of threshold agent” refers to a composition, mixture, or ingredient containing too little threshold agent to inhibit measurably the precipitation of water hardness present in or employed with such composition, mixture or ingredient.

The term “ware” refers to items used for cooking or eating, for example pots, pans, cooking utensils, plates, cups, glasses and eating utensils. The term “warewashing” refers to washing, rinsing or otherwise cleaning ware.

The term “water soluble” refers to a compound that can be dissolved in water at a concentration of more than 1 wt. %. The terms “sparingly soluble” or “sparingly water soluble” refer to a compound that can be dissolved in water only to a concentration of 0.1 to 1.0 wt. %. The term “water insoluble” refers to a compound that can be dissolved in water only to a concentration of less than 0.1 wt. %.

The term “water treatment product” refers to a product that reduces solubilized water hardness ions (e.g., Ca⁺⁺ and Mg⁺⁺ ions).

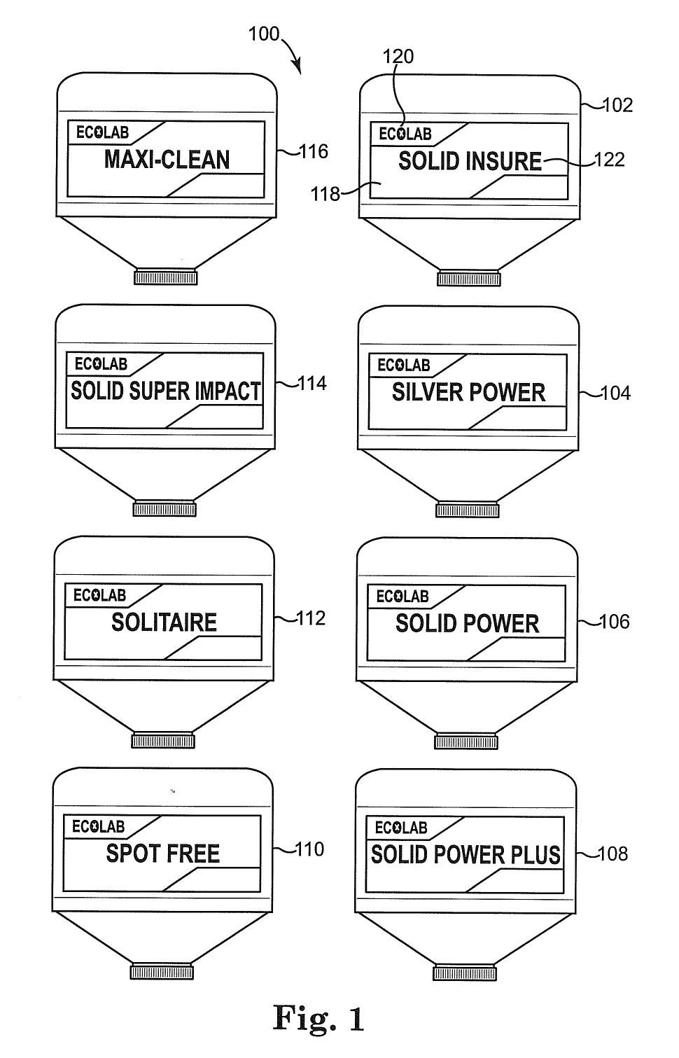

FIG. 1 shows a family 100 of cleaning products sold under a unifying brand (in this case, ECOLAB™ from Ecolab, Inc.). The family includes a detergent 102 sold under the trademark SOLID INSURE, a detergent 104 sold under the trademark SILVER POWER, a detergent 106 sold under the trademark SOLID POWER, a detergent 108 sold under the trademark SOLID POWER PLUS, a detergent 110 sold under the trademark SPOT FREE, a detergent 112 sold under the trademark SOLITAIRE, a detergent 114 sold under the trademark SOLID SUPER IMPACT and a detergent 116 sold under the trademark MAXI-CLEAN. The various family members share similar labels and other trade dress, and provide at least a minimum level of expected cleaning performance for members manufactured or sold as a part of the brand family. Labels such as label 118 on detergent 102 provide a place on which the brand 120 may be printed together with a further trademark designation 122, the manufacturer's name, and information for consumers (for example, graphical indicia or text) concerning the manner in which detergent 102 may be stored and used. A variety of packages, containers, dispensers and refill products may be employed for cleaning products such as detergents 102 through 116, for example those shown in U.S. Pat. Nos. 4,687,121, 4,826,661, 5,086,952, 5,389,344, 6,143,257 and 6,489,278.

The brands under which the disclosed cleaning products are sold will generally have national and in some cases international scope. However, the brands need not be the same in all countries and need not have the same owner from one country to another.

The disclosed methods may be used to formulate a wide variety of substitute cleaning products that are free of or substantially free of chelating agents (e.g., aminocarboxylates including any or all of those mentioned below), threshold agents (e.g., polycarboxylates including any or all of those mentioned below) or both chelating agents and threshold agents. Representative aminocarboxylates whose use may be reduced, substantially eliminated or eliminated include acids (or more commonly salts thereof, including sodium or potassium salts) such as EDTA, DTPA, NTA, methylglycinediacetic acid trisodium salt (MGDA), 1,3-diaminopropanetetraacetic acid (1,3-PDTA), 2-hydroxyethyliminodiacetic acid disodium salt (HEIDA), ethylene diamine disuccinic acid trisodium salt (EDDS), tetrasodium iminodisuccinate, tetrasodium 3-hydroxy-2,2′-iminodisuccinate (HIDS) and tetrasodium glutamate diacetate. Commercial versions of such aminocarboxylates include various DISSOLVINE™ chelating agents from Akzo Nobel Functional Chemicals bv; BAYPURE™ and TRILON™ chelating agents from BASF; VERSENE™, VERSENEX™ and VERSENOL™ chelating agents from Dow Chemical Company; OCTAQUEST™ chelating agents from Octel Performance Chemicals and HIDS chelating agent from Nippon Shokubai.

Additional chelating agents which are sometimes used together with aminocarboxylates or polycarboxylates and whose use may also be reduced, substantially eliminated or eliminated include phosphorus-containing and especially phosphate-containing acids (or more commonly salts thereof, including sodium or potassium salts) such as sodium tripolyphosphate (STPP) and sodium etidronate, and non-phosphorus-containing chelating agents such as sodium citrate and sodium gluconate. It generally will be desirable to reduce, substantially eliminate or eliminate such additional chelating agents, as they may otherwise tend to form complexes with magnesium ions and thereby compromise the performance of the disclosed magnesium compound. In many instance such additional chelating agents have undesirable environmental disadvantages (e.g., phosphates) or high cost, and their role may safely, effectively or inexpensively be replaced by the disclosed magnesium compounds. Zeolites capable of complexing calcium salts without complexing magnesium compounds (e.g., zeolite A) may be retained if desired. However, zeolites desirably are also reduced, substantially eliminated or eliminated to the extent their role may effectively or inexpensively be replaced by the disclosed magnesium compounds.

Representative polycarboxylates whose use may be reduced, substantially eliminated or eliminated include acrylate, methacrylate and olefin/maleic acid polymers and copolymers. Additional threshold agents which are sometimes used together with aminocarboxylates or polycarboxylates and whose use may also be reduced, substantially eliminated or eliminated include polyethers, polyethylenimines, polyvinylpyrrolidones, vinlyimidazoles and naphthalene sulfonic acid-formaldehyde condensation products. It generally will be desirable to reduce, substantially eliminate or eliminate such additional threshold agents, as their role can effectively and inexpensively be replaced by the disclosed magnesium compounds. Exemplary polycarboxylates and additional threshold agents include the SOKALAN™, TAMOL™ and LUPASOL™ polymers available from BASF; GANTREZ™ polymers from ISP Performance Chemicals and ACUSOL™ polymers from Rohm & Haas.

A variety of magnesium compounds may be employed in the disclosed method. The magnesium compound may offset the effect of solubilized water hardness ions (e.g., Ca⁺⁺ ions) and prevent lime scale (calcite) formation. The magnesium compound may be water soluble or water insoluble, and may be inorganic or organic. Exemplary water soluble magnesium compounds include magnesium acetate, magnesium benzoate, magnesium bromide, magnesium bromate, magnesium chlorate, magnesium chloride, magnesium citrate, magnesium formate, magnesium hexafluorosilicate, magnesium iodate, magnesium iodide, magnesium lactate, magnesium molybdate, magnesium nitrate, magnesium perchlorate, magnesium phosphinate, magnesium salicylate, magnesium sulfate, magnesium sulfite, magnesium tartrate, magnesium thiosulfate and mixture thereof. Exemplary water insoluble magnesium compounds include magnesium carbonate, magnesium chromate, magnesium hydroxide and magnesium oxide. Magnesium chloride may be preferred for cleaning products in which clarity is important. Magnesium sulphate may be preferred for cleaning products in which exposure to metals and the avoidance of corrosion are important. A water insoluble magnesium compound may advantageously be combined with a water soluble magnesium compound (for example, at a ratio of water soluble to water insoluble magnesium compound of about 1:10 to about 10:1, about 1:5 to about 5:1, or about 1:3 to about 3:1) to slow the speed at which the water soluble magnesium compound dissolves. Magnesium compounds in the form of magnesium salts may be employed, and may be provided as hydrated salts or anhydrous salts. An exemplary subclass of magnesium compounds includes magnesium salts with an anion that also forms a soluble salt with calcium. Exemplary such salts include magnesium acetate, magnesium benzoate, magnesium bromide, magnesium bromate, magnesium chlorate, magnesium chloride, magnesium formate, magnesium iodide, magnesium lactate, magnesium nitrate, magnesium perchlorate, magnesium phosphinate, magnesium salicylate and mixtures thereof. Another exemplary subclass of magnesium compounds includes those approved as Generally Recognized As Safe (GRAS) for direct food contact, including magnesium chloride and magnesium sulfate.

The disclosed methods employ sufficient magnesium compound to provide comparable or improved cleaning performance when the substitute cleaning product contains or is used with hard water. The magnesium compound amount may vary based on factors including the expected source water hardness and expected ratio of magnesium to calcium in such source water, the presence or absence of other substances in the water, in the cleaning product or in a companion product which might be used together with the cleaning product (e.g., substances including chelating agents, threshold agents and other ingredients which might complex, consume or otherwise compromise the performance of the magnesium compound and which may be present in trace or deliberately increased amounts), the cleaning task or tasks to be performed and the site in which they will be performed, and on the chosen magnesium compound and its degree of hydration if any. As a useful guide, a water soluble magnesium compound desirably is present in an amount sufficient to provide a 1:1 or greater molar ratio of magnesium ions to calcium ions at the cleaning site, for example Mg:Ca molar ratios greater than or equal to 1:1, 1.2, 1.3, 1.4, 1.5 or 2.0. The Mg:Ca molar ratio may for example also be less than or equal to 5:1, 4:1 or 3:1. In general, Mg:Ca molar ratios between about 2:1 and 3:1 will provide very desirable results. Ratios above 3:1 and even above 5:1 may also provide very desirable results, but may represent a waste of superfluous magnesium compound. As a further useful guide, a water insoluble magnesium compound may for example be about 1 to about 50 wt. % of a solid cleaning compound.

The expected source water hardness, expected ratio of magnesium to calcium in such source water, chosen magnesium compound and its degree of hydration if any are of particular interest when selecting a magnesium compound amount. For example, if using magnesium chloride hexahydrate (MgCl₂.6H₂O, M.W. 203.3) the following amounts of the hydrated salt may be employed to obtain a 2:1 Mg:Ca molar ratio at the cleaning site:

| | | |
|---|---|---|
| Source Water Mg:Ca Ratio | 0.7 | 0.5 |

| Source Water Hardness, | | |
|---|---|---|
| expressed as CaCO₃ | | |
| Grains/Gallon | PPM | MgCl₂•6H₂O, PPM |

| | | | |
|---|---|---|---|
| 5 | 85 | 130 | 170 |
| 10 | 170 | 200 | 340 |
| 15 | 255 | 390 | 520 |
| 20 | 340 | 525 | 860 |

The amounts shown above may readily be adjusted for other source water Mg:Ca molar ratios, source water hardness levels, magnesium compounds, degrees of hydration, and target Mg:Ca ratios at the cleaning site.

The magnesium compound may be incorporated into the substitute cleaning compound, employed in a water treatment product, or both. Further details regarding use of the magnesium compound in a cleaning product may be found in the above-mentioned U.S. patent application Ser. No. 12/114,327 filed May 2, 2008, and in U.S. patent application Ser. No. 12/114,486, filed May 2, 2008 and entitled “Cleaning Compositions with Water Insoluble Conversion Agents and Methods of Making and Using Them”. Further details regarding use of the magnesium compound in a water treatment product may be found, for example, in U.S. patent application Ser. No. 12/114,448, filed May 2, 2008 and entitled “Water Treatment System and Downstream Cleaning Methods”.

The disclosed substitute cleaning product or cleaning system may be manufactured, packaged or sold forms in a variety of forms including liquids, gels and solids, and in ready-to-use (RTU) or concentrated forms intended to be diluted with water prior to use.

The substitute cleaning product or cleaning system may include a variety of ingredients which serve to maintain or improve cleaning performance, including sources of alkalinity, surfactants or surfactant systems (including anionic, nonionic, cationic and zwitterionic surfactants and surfactant systems), pH modifiers (e.g., organic or inorganic sources of alkalinity or pH buffering agents), builders (e.g., inorganic builders such as silicates, carbonates, sulfates, salts or acid forms thereof), processing aids, active oxygen compounds, glass or metal corrosion inhibitors, activators, rinse aids, functional materials, bleaching agents, defoaming agents, anti-redeposition agents, stabilizing agents, enzymes, detersive polymers, softeners, sources of acidity, solubility modifiers, bleaching agents, effervescent agents, and activators for the source of alkalinity. Additional adjuvants include antimicrobial agents, secondary hardening (viz., solidification) agents, detergent fillers, aesthetic enhancing agents (e.g., dyes, odorants and perfumes), lubricants, dispersants and preservatives. The amounts and types of such adjuvants may for example be determined empirically or with the assistance of suppliers.

The substitute cleaning product or cleaning system desirably has one or more of the following product attributes, including being free of phosphorus, free of NTA, useable in a pH range of about 9-13, effective in less than 3 minutes after the start of use, stable when formulated with soda ash or sodium hydroxide whether in liquid, gel or solid formulations, low in toxicity (including low in aquatic toxicity, biodegradable, and in compliance with all current and announced regulatory requirements in the country or region of sale.

The substitute cleaning product or cleaning system may also contain or be mixed with water. The water may be treated, untreated or softened water including municipal or well water, deionized water, distilled water or water in any other suitable form. Water may represent for example at least 5 wt. %, at least 10 wt. %, at least 20 wt. %, at least 25 wt. %, at least 30 wt. %, at least 40 wt. %, at least 50 wt. % or at least 60 wt. % of the substitute cleaning product, cleaning system or diluted solution thereof. Water may for example also represent less than 80 wt. %, less than 70 wt. %. less than 60 wt. %, less than 55 wt. %, less than 50 wt. %, less than 40 wt. %, less than 30 wt. % or less than 20 wt. % of the substitute cleaning product, cleaning system or diluted solution thereof. The substitute cleaning product or cleaning system may also be substantially water-free, for example in solid form. RTU or diluted use solutions of the substitute cleaning composition or cleaning system may be clear, translucent or opaque, may be homogenous or may have more than one phase, and may be solutions, dispersions or emulsions. Diluted use solutions may for example be made at concentrate:water ratios of about 1:500-1:10, or about 1:250-1:1. The desired use concentration may for example vary somewhat depending on the desired application method (manual spray, soak, washing machine, instrument washer, etc.). If manufactured or sold in solid form, the substitute cleaning composition or cleaning system desirably retains such solid form when exposed to elevated temperatures, e.g., temperatures of up to about 38° C. or up to about 50° C.

The substitute cleaning composition and cleaning system may be used on a variety of hard and soft surfaces including those mentioned above and other surfaces including food-related surfaces, health care surfaces and transportation surfaces. Exemplary food-related surfaces include production, processing, cooking and serving surfaces. Exemplary health care surfaces include surfaces employed as part of a health care activity (including human and animal care), for example surfaces of instruments, devices, carts, cages, furniture, structures, buildings and the like. Exemplary transportation surfaces include vehicles, service facilities, wash facilities and the like.

The invention is further illustrated in the following non-limiting examples.

### EXAMPLE 1

### Water Treatment Using Low Water Solubility Magnesium Media

Several experiments were performed to evaluate the effect of various conversion agents on water hardness and ware washing applications. In a first experiment, the ability of a solid source of magnesium oxide to reduce solubilized water hardness was evaluated by passing water through a media bed of magnesium oxide particles. The particles had an average size of about 900 micrometers, and the media was held in a tank. The amounts of calcium and magnesium ions in the water were measured before and after treatment of the water by passage through the media bed. The total dissolved solids (TDS), water hardness, and pH were also measured both before and after treatment. The results are shown in Table 1:

TABLE 1

| | Before | After |
|---|---|---|
| Measured Property | Treatment | Treatment |
| pH | 7.6 | 9.3 |
| TDS (ppm) | 360.5 | 201.4 |
| Water Hardness (grains) | 18 | 12 |
| Ca⁺⁺ ions present (ppm) | 66 | 9 |
| Mg⁺⁺ ions present (ppm) | 28 | 48 |

As can be seen from the data in Table 1, the pH of the treated water rose slightly after treatment. Without wishing to be bound by any particular theory, this is may be due to magnesium oxide in the media bed dissolving into Mg⁺⁺ and OH⁻ once contacted by the water. It was also observed that the total solubilized water hardness decreased by about 35%, and the total solubilized Ca⁺⁺ decreased by about 86%. Overall, treatment of the water source with a solid magnesium oxide conversion agent provided beneficial effects including reduced solubilized water hardness and reduced total dissolved solids in the treated water.

In a second experiment, calcite was added to the magnesium oxide media bed to provide a set of water samples containing differing Mg:Ca ratios. The amounts of magnesium ions and calcium ions in the treated water were measured after treatment with various mixtures of magnesium oxide and calcite. The results are shown in Table 2:

TABLE 2
Percent Make-Up in Treatment Tank (%)

| | | | | | |
|---|---|---|---|---|---|
| MgO/Calcite | 100/0 | 75/25 | 50/50 | 25/75 | 0/100 |

Treated Water Composition (ppm)

| | | | | | |
|---|---|---|---|---|---|
| Mg⁺⁺ | 48.3 | 45.3 | 39.0 | 36.8 | 26.0 |
| Ca⁺⁺ | 8.96 | 13.5 | 25.1 | 37.3 | 63.9 |

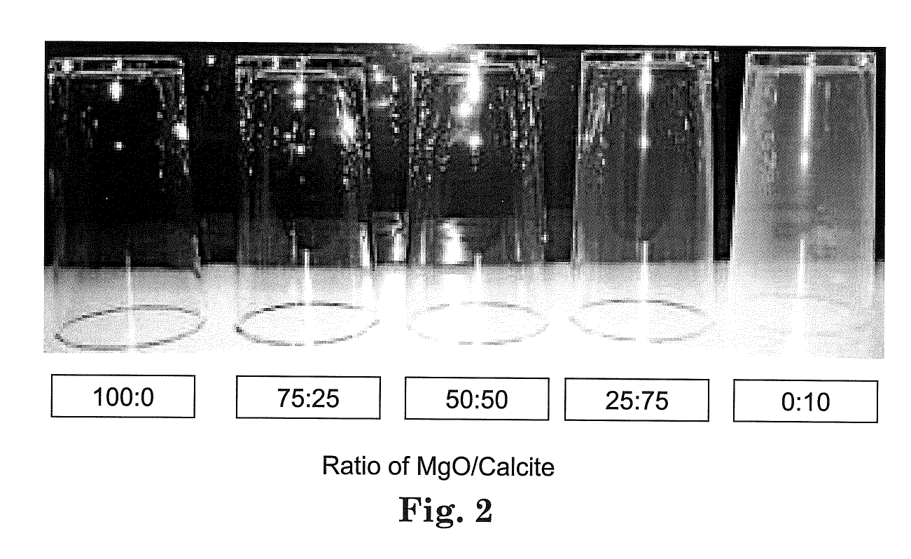

Next, drinking glasses were repeatedly washed and rinsed without detergent, rinse aid or drying cycles in a Hobart AM-14 automatic ware washing machine using water treated with the MgO/Calcite mixtures. After 100 cycles the glasses were evaluated for spotting and filming. Filming appeared to provide a more reliable indicator than spotting for evaluating glass appearance, since heavy films tended to prevent spots from appearing or made spots difficult to discern. The washed glasses are shown in FIG. 2. Glasses washed with water treated in the 100% MgO/0% calcite and 75% MgO/25% calcite beds exhibited little or no spotting. The amount of spotting and filming increased on the glasses as the amount of MgO decreased and the amount of calcite increased.

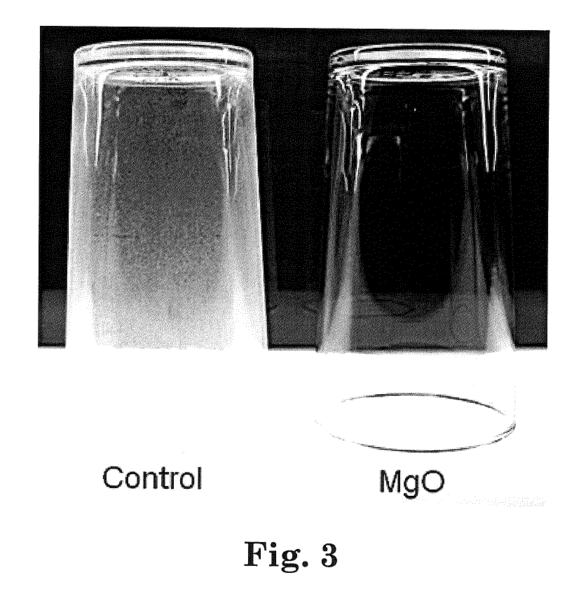

In a third experiment, a Hobart AM-14 automatic ware washing machine was supplied with water having 17 grains hardness in its untreated state. The water was optionally passed through a treatment tank containing magnesium oxide but no calcite. The untreated or treated water was supplied directly to the machine sump so that it would affect both the wash and rinse cycles. No detergent or rinse aid was employed. After 100 cycles, drinking glasses washed with untreated or treated water were evaluated for spotting and filming. The washed glasses are shown in FIG. 3. The glass washed with water treated in the MgO bed exhibited little or no spotting, whereas the glass washed with untreated water exhibited substantial filming and spotting.

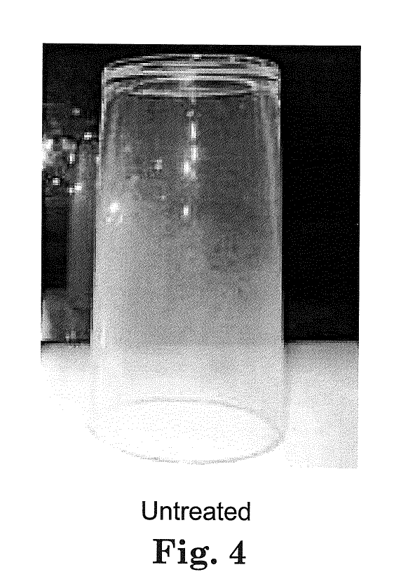

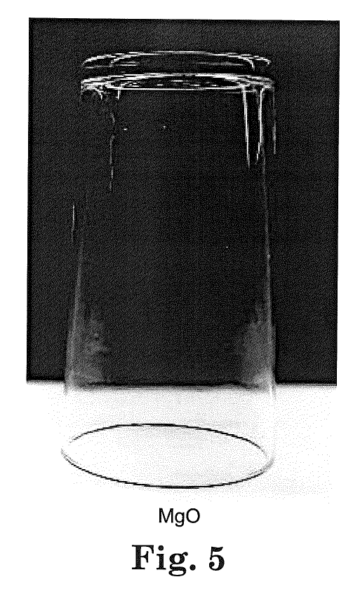

In a fourth experiment, the third experiment was repeated using two ware washing detergent cleaning products. The first detergent was SOLID POWER™, a branded product manufactured and sold to the institutional cleaning market by Ecolab Inc. The SOLID POWER detergent contained about 0.8% polyacrylic acid (active ingredients), 14% sodium tripolyphosphate and 2% sodium phosphinate chelants. The detergent was added to the ware washing machine in an amount sufficient to provide about 1000 ppm detergent in the wash cycle, and was used with untreated water and a standard rinse aid (RINSE-DRY™, from Ecolab, Inc.) added after the wash cycle. The second detergent was a substitute formulation completely free of chelating agents and containing 32 parts NaOH, 35 parts RU SILICATE™ sodium silicate (available from Philadelphia Quartz), 1 part polyether siloxane, 2 parts PLURONIC™ N3 ethylene oxide/propylene oxide block copolymer (a nonionic surfactant and rinse aid available from BASF), 1 part of a nonionic defoaming agent, 10 parts soda ash, 12 parts sodium sulfate, 1 part sodium metasilicate and 6 parts water. The chelating agent-free substitute formulation was added to the warewashing machine in an amount sufficient to provide about 650 ppm detergent in the wash cycle, and was used with treated water and without additional rinse aid. The glasses were washed for 100 cycles. The washed glasses are shown in FIG. 4 (washed with SOLID POWER detergent) and FIG. 5 (washed with the substitute formulation) after completion of the 100 cycle test. The glass washed using the substitute formulation and treated water exhibited significantly less filming and spotting than the glass washed with the SOLID POWER detergent, untreated water and a rinse aid. After completion of the 100 cycles, the inside of the ware washing machine employing the substitute formulation and treated water had a much cleaner appearance, with no visible scale, compared to the ware washing machine employing the SOLID POWER detergent, untreated water and a rinse aid.

The above experiments indicate that a cleaning system employing the substitute formulation could be manufactured and sold under the SOLID POWER brand for use with the disclosed magnesium compound water treatment, to provide at least comparable and likely improved cleaning performance compared to that obtained using SOLID POWER detergent and untreated water.

### EXAMPLE 2

### Substitute Rinse Aid Using Water Soluble Magnesium Compounds

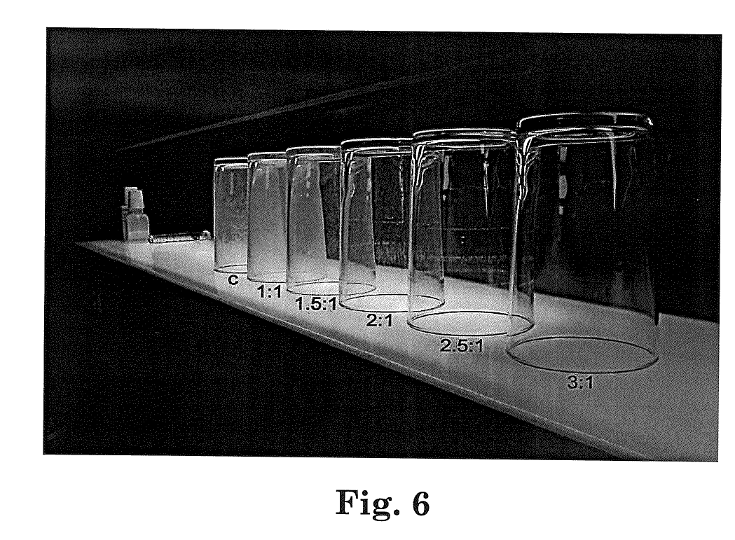

In a first experiment, drinking glasses were run though a dishwashing machine for 100 cycles using untreated 17 grain hard water for both the wash and rinse cycles with no added detergent or rinse agent. In a second experiment, drinking glasses were run though a dishwashing machine for 100 cycles using untreated 17 grain hard water, no added detergent, and with 700 ppm of the water soluble magnesium compound magnesium sulfate heptahydrate introduced as the sole rinse agent. The glasses from the second experiment had significantly less spotting and filming than those from the first experiment. In a third experiment, magnesium sulfate was introduced at varying concentrations to provide molar ratios of magnesium ion to calcium ion in the rinse cycle of 1:1, 1.5:1, 2:1, 2.5:1, and 3:1, again without added detergent. The results from the first and third experiments are shown in FIG. 6. Glass C is a control glass (from the first experiment) washed and rinsed using hard water alone. The remaining glasses are from the third experiment and are labeled to show the molar ratio of magnesium to calcium. These ratios are based on the total amount of magnesium present including that present in the incoming water. Glass C has a severely clouded appearance, and looks like it had been frosted or etched. Glass 1:1 is even cloudier or more frosted than glass C. Glasses 1.5:1 through glass 3:1 are increasingly clearer in appearance than the previous (lower ratio) glasses. Glass 3:1 has substantially no filming, spotting, cloudiness, or etched appearance and looked essentially like a brand new glass. Rinsing the glasses using a 1:1 molar ratio of magnesium to calcium increased precipitation of hard water scale relative to the control. Improvements were obtained by using an excess of magnesium ion over calcium ion, with measureable improvements likely to be found above 1:1 and below 1.5:1, significant improvements being observed above 1.5:1, and glasses completely free of lime scale being observed at a 3:1 ratio. Higher ratios could be employed if desired. Hard water containing only added hardness ion (Mg²⁺) accordingly reduced formation of lime scale on glasses when magnesium ion was in a molar excess over calcium ion.

The Example 2 experiments indicate that a cleaning system employing the Example 1 substitute formulation could be manufactured and sold under the SOLID POWER brand for use with untreated water (viz., without the disclosed magnesium compound water treatment) and with a rinse aid containing a water-soluble magnesium compound, to provide at least comparable and likely improved cleaning performance compared to that obtained using SOLID POWER detergent and untreated water.

The Example 1 and Example 2 experiments also indicate that the Example 1 substitute formulation could be further altered to provide a further substitute cleaning product which could be used with treated or untreated water, by including about 5 to about 50 wt. % of a water soluble magnesium compound (measured on an anhydrous basis, with the desired amount depending in part on the expected water hardness). Doing so would provide a further substitute cleaning product that could be in the altered substitute formulation manufactured and sold under the SOLID POWER brand and used with untreated water, to provide at least comparable and likely improved cleaning performance compared to that obtained using SOLID POWER detergent and untreated water. Especially desirable cleaning performance should be obtained by using such a further substitute cleaning product together with a rinse aid, especially one containing a water-soluble magnesium compound.

### EXAMPLE 3

### Substitute Powdered Laundry Detergent Formulation

“BIOLOGICAL ARIEL with febreze effect” is a laundry detergent powder said by its manufacturer (Proctor & Gamble Co., see www.scienceinthebox.com) to contain the ingredients shown in Table 3:

TABLE 3
Ingredients

Sodium carbonate
Sodium sulfate
Sodium carbonate peroxide
Sodium dodecylbenzenesulfonate
Sodium C₁₂₋₁₅ pareth sulfate
Sodium acrylic acid/methacrylic acid copolymer
Sodium silicoaluminate
Tetraacetylethylenediamine
Citric acid
Water
Ethoxylated hexamethylenediamine quaternized
Cellulose gum
Magnesium sulfate
C₁₃₋₁₅ pareth-7
Perfume
Perfume
Tetrasodium etidronate
Sodium toluenesulfonate
Sodium chloride
Ceteareth-80
Glycosidase
Trisodium ethylenediamine disuccinate
Fluorescent brightener 260
Protease
Ceteareth-25
Sulfuric acid
Glycosidase
Glycosidase
Phenylpropyl ether methicone
PEI perfume modified
Sodium polyacrylate
Dodecylbenzene sulfonic acid
Colorant
Colorant
Zinc phthalocyanine sulfonate
Sodium hydroxide
Butylphenyl methylpropional
Limonene

The Table 3 ingredients are believed to be listed in descending order from the largest to the smallest concentrations. Some ingredients (e.g., perfume and colorant) appear more than once due in all likelihood to the use of different types of each of these ingredients.

A substitute cleaning product could be formulated by reducing or eliminating one or more and preferably each of the sodium acrylic acid/methacrylic acid copolymer, trisodium ethylenediamine disuccinate and sodium polyacrylate, and adding to the formulation sufficient water soluble magnesium compound to overcome the presence of water hardness ions in water used to manufacture or used with such substitute cleaning product. For example, the substitute formulation could contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride or magnesium sulfate. The amounts of citric acid and tetrasodium etidronate desirably also would be reduced or eliminated, as they may otherwise compromise the performance of the added magnesium compound. The sodium silicoaluminate (Zeolite) could be left in the formulation if it does not complex magnesium ions, but desirably would also be reduced or eliminated since its function could effectively and inexpensively be performed by the added magnesium compound. The resulting substitute formulations should provide laundry detergents containing less aminocarboxylate or polycarboxylate, preferably laundry detergents that are free of or substantially free of aminocarboxylate and polycarboxylate, and most preferably laundry detergents that are free of or substantially free of chelating agents and threshold agents, while providing comparable or improved cleaning performance sufficient to enable the manufacture or sale of the substitute cleaning product under the ARIEL brand without loss of brand value.

### EXAMPLE 4

### Substitute Powdered Laundry Detergent Formulation

BOLD™ 2in1 Crushed Silk & Jasmine laundry detergent powder is said by its manufacturer (Proctor & Gamble Co., see www.scienceinthebox.com) to contain the ingredients shown in Table 4:

TABLE 4
Ingredients

Sodium sulfate
Sodium carbonate
Sodium dodecylbenzenesulfonate
Sodium silicoaluminate
Bentonite
Sodium carbonate peroxide
Water
Sodium acrylic acid/methacrylic acid copolymer
Citric acid
C₁₃₋₁₅ pareth-7
Dimethicone
Tetraacetylethylenediamine
Perfume
Sodium tallowate
Perfume
Sodium dodecylbenzenesulfonate
Hydroxyethyl laurdimonium chloride
Tetrasodium etidronate
Magnesium sulfate
Sodium chloride
C10-16 alkylbenzene sulfonic acid
Polyethylene glycol
Protease
Glycosidase
Fluorescent brightener 260
Perfume
Trisodium ethylenediamine disuccinate
Cellulose gum
Sodium silicate
Phenylpropyl ether methicone
Starch, sodium octenyl succinate
Sodium polyacrylate
Sodium hydroxide
Dodecylbenzene sulfonic acid
Dichlorodimethylsilane RX with Silica
Colorant
Zinc phthalocyanine sulfonate
Glycerine
Colorant
Sodium laureth sulfate
Limonene

The Table 4 ingredients are believed to be listed in descending concentration order as was done for the ingredients in Table 3. Sodium dodecylbenzenesulfonate is listed more than once, due possibly to an error or because it may have been added in more than one form or at different stages during manufacture of the cleaning product. The formulation also includes some magnesium sulfate, believed to be present in order to substitute for sodium ion in the surfactant sodium dodecylbenzenesulfonate and thereby alter the surfactant performance or solution characteristics.

A substitute cleaning product could be formulated by reducing or eliminating one or more and preferably each of the sodium acrylic acid/methacrylic acid copolymer, trisodium ethylenediamine disuccinate and sodium polyacrylate, and adding to the formulation sufficient water soluble magnesium compound to overcome the presence of water hardness ions in water used to manufacture or used with such substitute cleaning product. For example, the substitute formulation may contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride or magnesium sulfate (in the case of magnesium sulfate, beyond the amount already present). The amounts of citric acid and tetrasodium etidronate desirably also would be reduced or eliminated, as they may otherwise compromise the performance of the added magnesium compound. The sodium silicoaluminate (Zeolite) could be left in the formulation if it does not complex magnesium ions, but desirably would also be reduced or eliminated since its function could effectively and inexpensively be performed by the added magnesium compound. The resulting substitute formulations should provide laundry detergents containing less aminocarboxylate or polycarboxylate, preferably laundry detergents that are free of or substantially free of aminocarboxylate and polycarboxylate, and most preferably laundry detergents that are free of or substantially free of chelating agents and threshold agents, while providing comparable or improved cleaning performance sufficient to enable the manufacture or sale of the substitute cleaning product under the BOLD brand without loss of brand value.

### EXAMPLE 5

### Substitute Powdered Laundry Detergent Formulation

DREFT™ Regular Powder laundry detergent is said by its manufacturer (Proctor & Gamble Co., see www.scienceinthebox.com) to contain the ingredients shown in Table 5:

TABLE 5
Ingredients

Sodium silicoaluminate
Sodium sulfate
Sodium bicarbonate
Sodium dodecylbenzenesulfonate
Water
Sodium C₁₆₋₁₈ alkyl sulfate
C₁₃₋₁₅ pareth-7
Citric acid
Cellulose gum
Sodium acrylic acid/methacrylic acid copolymer
Ethoxylated hexamethylenediamine quaternized
Palm kernel acid
Protease
Sodium chloride
Perfume
Magnesium sulfate
Cellulase
Sodium carbonate
Trisodium ethylenediamine disuccinate
Glycosidase
Phenylpropyl ether methicone
Sodium polyacrylate
Dodecylbenzene sulfonic acid
Sodium hydroxide
Cetearyl alcohol
Alpha-isomethyl ionone
Citronellol
Hexyl cinnamal

The Table 5 ingredients are believed to be listed in descending concentration order as was done for the ingredients in Table 3. The formulation also includes some magnesium sulfate, believed to be present in order to substitute for sodium ion in the surfactant sodium dodecylbenzenesulfonate and thereby alter the surfactant performance or solution characteristics.

A substitute cleaning product could be formulated by reducing or eliminating one or more and preferably each of the sodium acrylic acid/methacrylic acid copolymer, trisodium ethylenediamine disuccinate and sodium polyacrylate, and adding to the formulation sufficient water soluble magnesium compound to overcome the presence of water hardness ions in water used to manufacture or used with such substitute cleaning product. For example, the substitute formulation may contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride or magnesium sulfate (in the case of magnesium sulfate, beyond the amount already present). The citric acid amount desirably also would be reduced or eliminated, as citric acid may otherwise compromise the performance of the added magnesium compound. The sodium silicoaluminate (Zeolite) could be left in the formulation if it does not complex magnesium ions, but desirably would also be reduced or eliminated since its function could effectively and inexpensively be performed by the added magnesium compound. The resulting substitute formulations should provide laundry detergents containing less aminocarboxylate or polycarboxylate, preferably laundry detergents that are free of or substantially free of aminocarboxylate and polycarboxylate, and most preferably laundry detergents that are free of or substantially free of chelating agents and threshold agents, while providing comparable or improved cleaning performance sufficient to enable the manufacture or sale of the substitute cleaning product under the DREFT brand without loss of brand value.

### EXAMPLE 6

### Substitute Dishwashing Detergent Formulation

FAIRY™ Active Burst Lemon dishwashing detergent powder is said by its manufacturer (Proctor & Gamble Co., see www.scienceinthebox.com) to contain the ingredients shown in Table 6:

TABLE 6
Ingredients

Pentasodium triphosphate
Sodium carbonate
Sodium carbonate peroxide
Water
C₁₃₋₁₅ alkyl ethoxylate butoxylate
Acrylic/sulphonic copolymer
Trideceth-7
Dipropylene glycol
Protease/glycosidase mix
Tetraacetylethylenediamine
Sodium silicate
Sodium sulfate
Protease
Polyethylene glycol 8000
Glycerine
Lauramine oxide
C₉₋₁₁ pareth-8
Perfume
Hydrozincite
Benzotriazole
Cellulose gum
Propylene glycol
Silica dimethicone silylate
Colorant
Zinc peroxide
(acetato)pentaamminecobalt dinitrate
Polyethylene glycol
Colorant
Sodium bicarbonate
Citral
Limonene
Linalool

The Table 6 ingredients are believed to be listed in descending order as was done for the ingredients in Table 3.

A substitute cleaning product could be formulated by reducing or eliminating the acrylic/sulphonic copolymer, and adding to the formulation sufficient water soluble magnesium compound to overcome the presence of water hardness ions in water used to manufacture or used with such substitute cleaning product. For example, the substitute formulation may contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride (where optimal clarity is desired) or magnesium sulfate (where clarity is of lesser concern and where the added amount is in addition to the amount already present). The pentasodium triphosphonate desirably also would be reduced or eliminated, as it is environmentally undesirable and may compromise the performance of the added magnesium compound. The resulting substitute formulations should provide dishwashing detergents containing less polycarboxylate, preferably dishwashing detergents that are free of or substantially free of polycarboxylate, and most preferably dishwashing detergents that are free of or substantially free of phosphates and other chelating agents or threshold agents, while providing comparable or improved cleaning performance sufficient to enable the manufacture or sale of the substitute cleaning product under the FAIRY brand without loss of brand value.

### EXAMPLE 7

### Substitute Carpet Cleaner Formulation

According to the Material Information Disclosure Statement (MIDS) provided in Canada, JOHNSON WAX PROFESSIONAL™ Heavy Duty Prespray SC (JohnsonDiversey, Inc.) contains the ingredients shown in Table 7:

TABLE 7

| Ingredients | CAS No. | Amount, wt. % |
|---|---|---|
| Styrene | 100-42-5 | 1-5% |
| Acrylic acid | 79-10-7 | 1-5% |
| Citric acid | 77-92-9 | 1-5% |
| Diethylene glycol butyl ether | 112-34-5 | 1-5% |
| Isopropyl alcohol | 67-63-0 | 1-5% |
| Trisodium salt of nitrilotriacetic acid | 5064-31-3 | 0.1-1.5% |
| (Trisodium NTA) | | |

A recent chemical analysis of JOHNSON WAX PROFESSIONAL Heavy Duty Prespray SC as sold in the U.S. indicated that the U.S. version or the same product may instead contain about 6.8 wt. % tetrasodium EDTA and about 2.2 wt. % citric acid. In either case, a substitute cleaning product could be formulated by reducing or eliminating the trisodium NTA or tetrasodium EDTA, and adding to the formulation sufficient water soluble magnesium compound to overcome the presence of water hardness ions in water used to manufacture or used with such substitute cleaning product. For example, the substitute formulation may contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride or magnesium sulfate. The citric acid desirably also would be reduced or eliminated, as it may otherwise compromise the performance of the added magnesium compound. The resulting substitute formulations should provide carpet cleaning sprays containing less aminocarboxylate, preferably carpet cleaning sprays that are free of or substantially free of aminocarboxylate, and most preferably carpet cleaning sprays that are free of or substantially free of chelating agents and threshold agents, while providing comparable or improved cleaning performance sufficient to enable the manufacture or sale of the substitute cleaning product under the JOHNSON WAX PROFESSIONAL brand without loss of brand value.

### EXAMPLE 8

### Gel Tablet Laundry Detergent Formulation

PERSIL™ Gel Tablets Bio laundry detergent is said by its U.K. supplier (Unilever, see http://www.unilever.com/PIOTI/EN/P1.asp) to contain ingredients having the functions shown in Table 8:

TABLE 8

| Ingredients | Function |
|---|---|
| Pentasodium Triphosphate | Builder |
| Sodium Carbonate Peroxide | Oxidizing Agent |
| Sodium Dodecylbenzenesulfonate | Surfactant |
| Sodium Silicoaluminate | Builder |
| Water | Bulking Agent |
| Sodium Sulfate | Bulking Agent |
| Sodium Cocoate | Surfactant |
| C₁₂₋₁₅ Pareth-5 | Surfactant |
| Sodium Carbonate | Buffering Agent |
| Tetraacetyl Ethylene Diamine | Oxidizing Agent |
| Dipropylene Glycol | Solvent |
| Sodium Citrate | No function |
| Polysorbate | Solvent |
| C₁₂₋₁₅ Pareth-7 | Surfactant |
| Ethylenediaminetetramethylene Phosphonic | Sequestrant |
| Acid Ca/Na salt | |
| Sodium Acetate | Tablet Disintegrant |
| Perfume | Fragrance |
| Sodium Stearate | Surfactant |
| Sodium Silicate | Builder |
| Maize Starch | Bulking Agent |
| Polyethylene Terephthalate | Suspending Agent |
| Synthetic Wax | Binder |
| Dimorpholinopyridazinone | Optical Brightener |
| Sodium Acrylic Acid/methacrylic acid | Structurant |
| Copolymer | |
| Simethicone | Antifoaming Agent |
| Cellulose Gum | Anti-redeposition Agent |
| Sodium Bentonite | Softness Extender |
| Sodium Chloride | Bulking Agent |
| Sodium Polyacrylate | Structurant |
| Glyceryl Stearate | Emulsifier |
| Polyoxymethylene Melamine | Encapsulation Agent |
| Protease | Enzyme |
| Imidazolidinone | Stabilizing Agent |
| Butylphenyl Methylpropional | Fragrance |
| Sodium Polyaryl Sulfonate | Surfactant |
| Amylase | Enzyme |
| Xanthan Gum | Viscosity Controlling Agent |
| Polymeric Blue 2 | Colorant |
| Polymeric Pink Al | Colorant |

The Table 8 ingredients are believed to be listed in descending order as was done for the ingredients in Table 3. Although sodium citrate is said to have “no function”, it is believed to serve as a chelating agent.

A substitute cleaning product could be formulated by reducing or eliminating one or more and preferably each of the sodium acrylic acid/methacrylic acid copolymer and sodium polyacrylate, and adding to the formulation sufficient water soluble magnesium compound to overcome the presence of water hardness ions in water used to manufacture or used with such substitute cleaning product. For example, the substitute formulation may contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride or magnesium sulfate. The amounts of pentasodium triphosphate, sodium citrate and ethylene diamine tetra methylene phosphonic acid Ca/Na salt desirably also would be reduced or eliminated, as they may otherwise compromise the performance of the added magnesium compound. The sodium silicoaluminate (Zeolite) could be left in the formulation if it does not complex magnesium ions, but desirably would also be reduced or eliminated since its function could effectively and inexpensively be performed by the added magnesium compound. The resulting substitute formulations should provide laundry detergents containing less polycarboxylate, preferably laundry detergents that are free of or substantially free of aminocarboxylate and polycarboxylate, and most preferably laundry detergents that are free of or substantially free of chelating agents and threshold agents, while providing comparable or improved cleaning performance sufficient to enable the manufacture or sale of the substitute cleaning product under the PERSIL brand without loss of brand value.

### EXAMPLE 9

### Substitute Powdered Laundry Detergent Formulation

PERSIL™ Universal-Pulver laundry detergent powder is said by its German supplier (Henkel AG & Co.) to contain the ingredients shown in Table 9:

TABLE 9
Ingredients

Sodium carbonate
Zeolite
Sodium carbonate peroxide
Sodium sulfate
Sodium dodecylbenzenesulfonate
Water
Tetraacetylethylenediamine
Sodium acrylic acid/methacrylic acid copolymer
C₁₂₋₁₈ fatty alcohol 7 EO
Sodium silicate
Cellulose gum
Sodium soap c₁₆₋₁₈
Tetrasodium etidronate
Perfume
Paraffin
Zea mays (corn) starch
C₁₂₋₁₈ fatty alcohol 5 EO
Sulfonated polyethylene terephthalate
Sodium hydroxide
Optical brightener
Corn flour
Linalool
Colorant
Benzyl salicylate
Hexyl cinnamal
Protease
Amylase
Mannanase
Cellulase

The Table 9 ingredients are believed to be listed in descending concentration order as was done for the ingredients in Table 3.

A substitute cleaning product could be formulated by reducing or eliminating the sodium acrylic acid/methacrylic acid copolymer, and adding to the formulation sufficient water soluble magnesium compound to overcome the presence of water hardness ions in water used to manufacture or used with such substitute cleaning product. For example, the substitute formulation may contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride or magnesium sulfate. The tetrasodium etidronate desirably also would be reduced or eliminated, as it may otherwise compromise the performance of the added magnesium compound. The Zeolite could be left in the formulation if it does not complex magnesium ions, but desirably would also be reduced or eliminated since its function could effectively and inexpensively be performed by the added magnesium compound. The resulting substitute formulations should provide laundry detergents containing less polycarboxylate, preferably laundry detergents that are free of or substantially free of aminocarboxylate and polycarboxylate, and most preferably laundry detergents that are free of or substantially free of chelating agents and threshold agents, while providing comparable or improved cleaning performance sufficient to enable the manufacture or sale of the substitute cleaning product under the PERSIL brand without loss of brand value.

### EXAMPLE 10

### Substitute Powdered Laundry Detergent Formulation

PERSIL™ Colour Care Biological Powder laundry detergent is said by its U.K. supplier (Unilever) to contain the ingredients shown in Table 10:

TABLE 10

| Ingredients | Function |
|---|---|
| Sodium Sulfate | Bulking Agent |
| Sodium Carbonate | Buffering Agent |
| Sodium Silicoaluminate | Builder |
| Sodium Dodecylbenzenesulfonate | Surfactant |
| Water | Bulking Agent |
| C₁₂₋₁₅ Pareth-5 | Surfactant |
| Sodium Silicate | Builder |
| C₁₂₋₁₅ Pareth-7 | Surfactant |
| Citric Acid | Builder |
| Sodium Acrylic Acid/Methacrylic Acid | Structurant |
| Copolymer | |
| Sodium Stearate | Surfactant |
| Stearic Acid | Surfactant |
| Perfume | Fragrance |
| Tetrasodium Etidronate | Sequestrant |
| Ethylenediaminetetramethylene Phosphonic | Sequestrant |
| Acid Ca/Na salt | |
| Maize Starch | Bulking Agent |
| Cellulose Gum | Anti-redeposition Agent |
| Polyethylene Terephthalate | Suspending Agent |
| Simethicone | Antifoaming Agent |
| Polyoxymethylene Melamine | Encapsulation Agent |
| Sodium Polyacrylate | Structurant |
| Butylphenyl Methylpropional | Fragrance |
| Glyceryl Stearate | Emulsifier |
| Imidazolidinone | Stabilizing Agent |
| Citronellol | Fragrance |
| Protease | Enzyme |
| Aluminum Silicate | Anticaking Agent |
| Xanthan Gum | Viscosity Controlling Agent |
| Amylase | Enzyme |
| Cellulase | Enzyme |
| CI 61585 | Colorant |
| CI 45100 | Colorant |
| CI 12490 | Colorant |
| CI 42090 | Colorant |
| CI 11680 | Colorant |

The Table 10 ingredients are believed to be listed in descending concentration order as was done for the ingredients in Table 3.

A substitute cleaning product could be formulated by reducing or eliminating the sodium acrylic acid/methacrylic acid copolymer and sodium polyacrylate, and adding to the formulation sufficient water soluble magnesium compound to overcome the presence of water hardness ions in water used to manufacture or used with such substitute cleaning product. For example, the substitute formulation may contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride or magnesium sulfate. The amounts of citric acid, tetrasodium etidronate and ethylenediaminetetramethylene phosphonic acid Ca/Na salt desirably also would be reduced or eliminated, as they may otherwise compromise the performance of the added magnesium compound. The sodium silicoaluminate (Zeolite) could be left in the formulation if it does not complex magnesium ions, but desirably would also be reduced or eliminated since its function could effectively and inexpensively be performed by the added magnesium compound. The resulting substitute formulations should provide laundry detergents containing less polycarboxylate, preferably laundry detergents that are free of or substantially free of aminocarboxylate and polycarboxylate, and most preferably laundry detergents that are free of or substantially free of chelating agents and threshold agents, while providing comparable or improved cleaning performance sufficient to enable the manufacture or sale of the substitute cleaning product under the PERSIL brand without loss of brand value.

### EXAMPLE 11

### Substitute Bar Soap Formulation

DOVE™ Cream Bar hand soap is said by its U.K. supplier (Unilever, see http://www.unilever.com/PIOTI/EN/P1.asp) to contain ingredients having the functions shown in Table 11:

TABLE 11

| Ingredients | Function |
|---|---|
| Sodium Lauroyl Isethionate | Surfactant |
| Stearic Acid | Humectant |
| Sodium Palmitate | Surfactant |
| Water | Solvent |
| Lauric Acid | Humectant |
| Sodium Isethionate | Surfactant |
| Sodium Stearate | Surfactant |
| Cocamidopropyl Betaine | Surfactant |
| Sodium Palm Kernelate | Surfactant |
| Perfume | Fragrance |
| Glycerin | Humectant |
| Sodium Chloride | Viscosity Controlling Agent |
| Zinc Oxide | Additive |
| Citric Acid | Antioxidant |
| Tetrasodium EDTA | Sequestrant |
| Tetrasodium Etidronate | Sequestrant |
| Alumina | Additive |
| Alpha-Isomethyl Ionone | Fragrance |
| Benzyl Alcohol | Fragrance |
| Butylphenyl Methylpropional | Fragrance |
| Citronellol | Fragrance |
| Coumarin | Fragrance |
| Hexyl Cinnamal | Fragrance |
| Limonene | Fragrance |
| Linalool | Fragrance |
| CI 77891 | Colorant |

The Table 11 ingredients are believed to be listed in descending order as was done for the ingredients in Table 3.

A substitute cleaning product could be formulated by reducing or eliminating the tetrasodium EDTA, and adding to the formulation sufficient water soluble magnesium compound to overcome the presence of water hardness ions in water used to manufacture or used with such substitute cleaning product. For example, the substitute formulation may contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride or magnesium sulfate. The citric acid and tetrasodium etidronate desirably also would be reduced or eliminated, as they may otherwise compromise the performance of the added magnesium compound. The sodium lauroyl isethionate and sodium isethionate are both lime scale dispersants which could be left in the formulation, reduced in amount or removed, as they may no longer be needed. The resulting substitute formulations should provide hand soaps containing less aminocarboxylate, preferably hand soaps that are free of or substantially free of aminocarboxylate and polycarboxylate, and most preferably hand soaps that are free of or substantially free of chelating agents and threshold agents, while providing comparable or improved cleaning performance sufficient to enable the manufacture or sale of the substitute cleaning product under the DOVE brand without loss of brand value.

### EXAMPLE 12

### Substitute Tile and Terrazzo Cleaner Formulation

According to the information provided to the US Department of Health and Human Services Household Products Database (see http://householdproducts.nlm.nih.gov), ZEP™ Tile and Terrazzo Cleaner (Enforcer Products Division of Acuity Brands, Inc.) contains the ingredients shown in Table 12:

TABLE 12

| | | Amount, |
|---|---|---|
| Ingredients | CAS No. | wt. % |
| Ethylenediaminetetraacetic acid (EDTA) | 60-00-4 | <5 |
| Ethanol/SD Alcohol 40 | 64-17-5 | 5-15 |
| 2-(2-Methoxyethoxy)ethanol | 111-77-3 | 5-15 |
| Nonylphenyl polyethoxylate | 9016-45-9 | — |

A substitute cleaning product could be formulated by reducing or eliminating the EDTA, and adding to the formulation sufficient water soluble magnesium compound to overcome the presence of water hardness ions in water used to manufacture or used with such substitute cleaning product. For example, the substitute formulation may contain about 2 to about 50 wt. %, about 5 to about 40 wt. % or about 11 to about 30 wt. % (measured on an anhydrous basis, with the desired amount depending in part on the expected water hardness) of a water soluble magnesium compound such as magnesium chloride or magnesium sulfate. The resulting substitute formulations should provide hard surface cleaners containing less aminocarboxylate, preferably hard surface cleaners that are free of or substantially free of aminocarboxylate and polycarboxylate, and most preferably hard surface cleaners that are free of or substantially free of chelating agents and threshold agents, while providing comparable or improved cleaning performance sufficient to enable the manufacture or sale of the substitute cleaning product under the ZEP brand without loss of brand value.

Various modifications and alterations of this invention will be apparent to those skilled in the art without departing from the scope of this invention. It should be understood that this invention is not limited to the illustrative embodiments set forth above.

We claim:

1. A method for formulating a cleaning product, which method comprises:
(a) manufacturing or selling, in association with a brand, a cleaning product containing sufficient aminocarboxylate or polycarboxylate to provide commercially acceptable cleaning performance when the cleaning product contains or is used with hard water;
(b) formulating a substitute cleaning product containing less of one or both of the aminocarboxylate or polycarboxylate, and containing sufficient magnesium compound to provide comparable or improved cleaning performance when the substitute cleaning product contains or is used with hard water; and
(c) manufacturing or selling the substitute cleaning product in association with the brand.

2. A method according to claim 1 wherein the substitute cleaning product is substantially free of aminocarboxylates.

3. A method according to claim 1 wherein the substitute cleaning product is free of aminocarboxylates.

4. A method according to claim 1 wherein the substitute cleaning product is substantially free of ethylenediaminetetraacetic acid and its salts.

5. A method according to claim 1 wherein the substitute cleaning product is free of ethylenediaminetetraacetic acid and its salts.

6. A method according to claim 1 wherein the substitute cleaning product is substantially free of diethylenetriaminepentaacetic acid and its salts.

7. A method according to claim 1 wherein the substitute cleaning product is substantially free of nitrilotriacetic acid and its salts

8. A method according to claim 1 wherein the substitute cleaning product is substantially free of polycarboxylates.

9. A method according to claim 1 wherein the substitute cleaning product is substantially free of polyacrylates, polymethacrylates and olefin/maleic acid copolymers.

10. A method according to claim 1 wherein the substitute cleaning product is free of polycarboxylates.

11. A method according to claim 1 wherein the substitute cleaning product is substantially free of phosphorus-containing chelating agents.

12. A method according to claim 1 wherein the substitute cleaning product is substantially free of chelating agents.

13. A method according to claim 1 wherein the substitute cleaning product is free of chelating agents.

14. A method according to claim 1 wherein the magnesium compound comprises magnesium acetate, magnesium benzoate, magnesium bromide, magnesium bromate, magnesium chlorate, magnesium chloride, magnesium citrate, magnesium formate, magnesium hexafluorosilicate, magnesium iodate, magnesium iodide, magnesium lactate, magnesium molybdate, magnesium nitrate, magnesium perchlorate, magnesium phosphinate, magnesium salicylate, magnesium sulfate, magnesium sulfite, magnesium tartrate, magnesium thiosulfate, hydrates thereof, or mixtures thereof.

15. A method according to claim 1 wherein the magnesium compound is a magnesium salt with an anion that also forms a soluble salt with calcium

16. A method according to claim 1 wherein the magnesium compound is selected from the group consisting of magnesium acetate, magnesium benzoate, magnesium bromide, magnesium bromate, magnesium chlorate, magnesium chloride, magnesium formate, magnesium iodide, magnesium lactate, magnesium nitrate, magnesium perchlorate, magnesium phosphinate, magnesium salicylate, hydrates thereof, and mixtures thereof

17. A method according to claim 1 wherein the magnesium compound comprises magnesium chloride.

18. A method according to claim 1 wherein the magnesium compound is water insoluble.

19. A method according to claim 1 wherein the magnesium compound comprises magnesium carbonate, magnesium hydroxide or magnesium oxide.

20. A method according to claim 1 wherein the magnesium compound comprises a mixture of water soluble and water insoluble magnesium compounds.

21. A method according to claim 1 wherein the substitute cleaning product contains at least about 5 wt. % magnesium compound.

22. A method according to claim 1 wherein the substitute cleaning product consists essentially of a source of alkalinity, magnesium compound and surfactant.

23. A method according to claim 1 wherein the substitute cleaning product has improved cleaning performance.

24. A method according to claim 1 wherein the substitute cleaning product comprises a liquid.

25. A method according to claim 1 wherein the substitute cleaning product comprises a ready to use solution.

26. A method according to claim 1 wherein the substitute cleaning product comprises a concentrate to which water is added prior to use.

27. A method according to claim 1 wherein the substitute cleaning product comprises a gel or paste.

28. A method according to claim 1 wherein the substitute cleaning product comprises a solid.

29. A method according to claim 1 wherein the substitute cleaning product comprises a ware washing detergent.

30. A method according to claim 1 wherein the substitute cleaning product comprises a laundry detergent.

31. A method according to claim 1 wherein the substitute cleaning product comprises a hard surface cleaner.

32. A method according to claim 1 wherein the substitute cleaning product comprises a soft surface cleaner.

33. A method according to claim 1, comprising manufacturing the substitute cleaning product, and selling the substitute cleaning product in association with the brand.

34. A method for formulating a cleaning system, which method comprises:
(a) manufacturing or selling, in association with a brand, a cleaning product containing sufficient aminocarboxylate or polycarboxylate to provide commercially acceptable cleaning performance when the cleaning product contains or is used with hard water;
(b) formulating a substitute cleaning product containing less of one or both of the aminocarboxylate or polycarboxylate;
(c) manufacturing or selling the substitute cleaning product in association with the brand, for use together with a water treatment product containing sufficient magnesium compound to provide comparable or improved cleaning performance when the substitute cleaning product is used with water treated using the water treatment product.
